(19) United States
(12) Patent Application Publication
(10) Pub. No.: US 2013/0308303 A1
(43) Pub. Date: Nov. 21, 2013

(54) Lighting System for an Architectural Ceiling Structure

(71) Applicants: George A. Greenholt, Chicago Ridge, IL (US); David E. Doubek, LaGrange, IL (US)

(72) Inventors: George A. Greenholt, Chicago Ridge, IL (US); David E. Doubek, LaGrange, IL (US)

(73) Assignee: d2 Lighting, LaGrange, IL (US)

(21) Appl. No.: 13/473,989

(22) Filed: May 17, 2012

(51) Int. Cl. F21S 8/06

(52) U.S. Cl. 362/150

(57) ABSTRACT

A lighting fixture forms at least a portion of a grid system for a suspended ceiling. The lighting fixture includes a runner having a substantially uniform, elongate, thin web coupled to a fixture base defining first and second flanges disposed on opposite sides of the web. The flanges support respective ceiling tiles. The base defines a fixture receptacle configured to receive a light source. A retainer may be supported by the fixture base to secure the light source in the fixture receptacle.

### FIELD OF THE DISCLOSURE

The present disclosure relates to lighting systems and fixtures adapted for use with architectural ceiling structures, and more particularly to lighting systems and fixtures that are incorporated into a grid system of a suspended ceiling.

### BACKGROUND OF THE DISCLOSURE

In construction and architecture, a suspended ceiling (also referred to as a drop or dropped ceiling) commonly is used to provide a finished ceiling surface in a room or other architectural space. In some instances, often in pre-existing structures, a suspended ceiling may be installed at some level below an existing ceiling to conceal an older damaged ceiling and/or provide a new appearance in the architectural space in which the suspended ceiling is installed. In other applications, suspended ceilings may be installed in newly-constructed architectural spaces, based in part on their relative ease of installation. In one noteworthy aspect, a suspended ceiling typically permits piping, wiring and ductwork to be easily and conveniently concealed in an area between a pre-existing ceiling (or other architectural framework) and the suspended ceiling itself. This area above the suspended ceiling commonly is referred to as a plenum.

FIG. 1 generally illustrates a typical suspended ceiling implementation. A conventional suspended ceiling 280 employs a grid system 1020 (also referred to as “grid-work”) of metal channels that are suspended on wires 128 or rods 1120 from an overhead structure (typically a pre-existing ceiling or architectural framework). The overhead structure is not explicitly shown in FIG. 1 to permit a view of the plenum 1140, or the area above the suspended ceiling 280. The metal channels of the grid system 1020 are configured to form a regularly spaced grid (typically a 2 foot-by-2 foot or a 2 foot-by-4 foot pattern) of square or rectangular cells between the channels. The cells of the grid typically are filled with tiles or panels 1080 which drop into the grid system 1020. The tiles 1080 generally are formed of lightweight materials having a variety of finished surface textures and colors, and may be particularly designed to facilitate acoustic or thermal isolation as well as fire safety. Once installed, the tiles 1080 may be easily removed and replaced to provide access as needed to the plenum 1140 (where there may be various wiring, pipes and ductwork requiring repair or alteration).

As indicated in FIG. 1, the grid system 1020 generally includes multiple main channels 1040, which are supported by the suspension wires 128 (or one or more rods 1120) attached to the overhead structure. The grid system also includes a plurality of cross channels 1060, which may be connected in an interlocking fashion to the suspended main channels. As illustrated in FIGS. 2(a), 2(b), and 2(c), the main channels and the cross channels of the grid system 1020 generally are in the shape of an upside-down “T”, wherein a bottom portion 1360 of the upside-down “T” forms a set of flanges, i.e., one flange on either side of a center rib 1340 of the channel, which supports adjacent ceiling tiles 1080 resting in the grid system 1020. Various tile edge-profiles are possible such that the bottom portion 1360 of a channel may be fully or partially exposed, or completely hidden; for example, FIG. 2(a) illustrates a first tile configuration (essentially square edges) resulting in an exposed bottom portion 1360 of a channel, FIG. 2(b) illustrates a second tile configuration (beveled edges) resulting in a recessed bottom portion 1360 of a channel, and FIG. 2(c) illustrates a third tile configuration (slotted edges) resulting in a hidden bottom portion 1360 of a channel, in which the flanges formed by the bottom portion of the channel are inserted into the slotted edges of the tiles.

FIGS. 3(a) and 3(b) illustrate the interlocking process of a cross channel 1060 and a main channel 1040 of the grid system 1020 shown in FIG. 1. Each main channel 1040 includes multiple slots 1300 punched periodically along the channel (e.g., every 12 inches) to provide for the attachment of cross channels 1060. Each cross channel 1060 includes end tabs 1320 that are pushed into and interlock with the slots 1300 along the main channels.

As also illustrated in FIG. 1, one or more of the cells formed by the grid system 1020 may be occupied by a lighting fixture 1200, which rests in the grid system 1020 in a manner similar to that of the tiles 1080. While the tiles 1080 are appreciably lightweight, the more substantial weight of the lighting fixture 1200 generally requires that the lighting fixture is itself suspended by wires 128 or otherwise coupled to and supported by an overhead structure, so that it does not rely exclusively on the grid system 1020 for support. Various types of LED, HID, fluorescent, and incandescent lighting fixtures having dimensions similar to those of the tiles 1080 are conventionally employed in suspended ceilings as substitutes for one or more tiles 1080. With reference again to FIG. 2(a), such lighting fixtures are generally configured to rest on top of the flanges formed by the bottom portion 1360 of the main and cross channels of the grid system 1020. Other types of conventional lighting fixtures (e.g., LED, HID, incandescent, fluorescent, halogen) are designed to be recessed into a hole cut into a tile 1080, such that the lighting fixture does not completely occupy a cell formed by the grid system, but merely occupies a portion of the cell area together with a remaining portion of the tile into which the fixture is recessed.

U.S. Pat. No. 8,061,865 to Piepgras et al. discloses apparatus for providing lighting in a grid system of a suspended ceiling that includes a large U-shaped central channel in which the light source is disposed. The channel also provides an air flow channel for dissipating heat. The size of the central channel occupies space that had conventionally been used by the ceiling tile, and therefore modified ceiling tile sizes are required for use with the Piepgras device. Additionally, the profile of the central channel departs considerably from conventional runner profiles, and therefore may be unfamiliar to the person assembling the grid system, thereby making the Piepgras device overly difficult to use.

### SUMMARY OF THE DESCRIPTION

In accordance with one aspect of the disclosure, a lighting fixture is disclosed that forms at least a portion of a grid system for a suspended ceiling. The lighting fixture includes a runner having an upper edge, a web having a first end coupled to the upper edge and a second end, a fixture base coupled to the web and defining first and second flanges disposed on opposite sides of the web, the first flange configured to support a first ceiling tile when the first ceiling tile is installed in the suspended ceiling, and the second flange configured to support a second ceiling tile when the second ceiling tile is installed in the suspended ceiling, and a fixture receptacle associated with the fixture base. A light source is secured inside the fixture receptacle.

In another aspect of the disclosure that may be combined with any of these aspects, a lighting fixture is provided that forms at least a portion of a grid system for a suspended ceiling. The lighting fixture includes a runner having an upper edge, a web having a first end coupled to the upper edge and a second end, a fixture base coupled to the web and defining first and second flanges disposed on opposite sides of the web, the first flange configured to support a first ceiling tile when the first ceiling tile is installed in the suspended ceiling, and the second flange configured to support a second ceiling tile when the second ceiling tile is installed in the suspended ceiling, spaced first and second side walls coupled to the base so that the base, first side wall, and second side wall define a fixture receptacle, a first support arm extending from the first side wall and into the fixture receptacle, and a second support arm extending from the second side wall and into the fixture receptacle. A light source is disposed inside the fixture receptacle, and a retainer is configured to extend from the first support arm to the second support arm, the retainer engaging the light source to secure the light source inside the fixture receptacle.

In another aspect of the disclosure that may be combined with any of these aspects, a lighting fixture is provided that forms at least a portion of a grid system for a suspended ceiling. The lighting fixture includes a runner having an upper edge, a substantially uniform, elongate, thin web having a first end coupled to the upper edge and a second end, a fixture base coupled to the web and defining first and second flanges disposed on opposite sides of the web, the first flange configured to support a first ceiling tile when the first ceiling tile is installed in the suspended ceiling, and the second flange configured to support a second ceiling tile when the second ceiling tile is installed in the suspended ceiling, spaced first and second side walls coupled to the base so that the base, first side wall, and second side wall define a fixture receptacle, a first support arm extending from the first side wall and into the fixture receptacle, and a second support arm extending from the second side wall and into the fixture receptacle. A light source is disposed inside the fixture receptacle, and a retainer is configured to extend from the first support arm to the second support arm, the retainer engaging the light source to secure the light source inside the fixture receptacle.

In another aspect of the disclosure that may be combined with any of these aspects, spaced first and second side walls may be coupled to the base, in which the base, first side wall, and second side wall define the fixture receptacle.

In another aspect of the disclosure that may be combined with any of these aspects, the first side wall includes a first support arm extending into the fixture receptacle and the second side wall includes a second support arm extending into the fixture receptacle, wherein the first and second support arms support the light source.

In another aspect of the disclosure that may be combined with any of these aspects, a retainer is configured to extend from the first support arm to the second support arm, the retainer engaging the light source to secure the light source inside the fixture receptacle.

In another aspect of the disclosure that may be combined with any of these aspects, the light source comprises a substrate body having first and second side surfaces, and the base includes first and second stops extending into the fixture receptacle, wherein the first and second stops are laterally spaced to respectively engage first and second side surfaces of the substrate body.

In another aspect of the disclosure that may be combined with any of these aspects, the runner is formed of a heat conductive material and further includes a cooling fin coupled to the web and extending substantially transversely relative to the web.

In another aspect of the disclosure that may be combined with any of these aspects, a lens is releasably coupled to the runner.

In another aspect of the disclosure that may be combined with any of these aspects, the fixture receptacle is disposed below the first and second flanges when the runner is installed in the suspended ceiling.

In another aspect of the disclosure that may be combined with any of these aspects, the upper edge of the runner comprises a reinforcing bulb.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 generally illustrates a typical suspended ceiling implementation according to the prior art.

FIGS. 2(a), 2(b) and 2(c) illustrate the general configuration of channels of a grid system and tiles supported by the channels of the grid system of the suspended ceiling shown in FIG. 1.

FIGS. 3(a) and 3(b) illustrate the interlocking process of a cross channel and a main channel of the grid system shown in FIG. 1.

FIG. 4 is a perspective view of a lighting system constructed according to the present disclosure.

FIG. 5 is a side elevation view, in cross-section, of an embodiment of a runner used in the lighting system of FIG. 4.

FIG. 6 is a plan view of an embodiment of a retainer used in the lighting system of FIG. 4.

FIG. 7 is a side elevation view, in cross-section, of another embodiment of a runner constructed according to the present disclosure.

FIG. 8 is a side elevation view, in cross-section, of a further embodiment of a runner constructed according to the present disclosure.

FIG. 9 is a side elevation view, in cross-section, of yet another embodiment of a runner constructed according to the present disclosure.

FIG. 10 is a perspective view of a retainer adapted for use with the runner of FIG. 9.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE DISCLOSURE

Following below are more detailed descriptions of various concepts related to, and embodiments of, methods and apparatus for providing lighting from a grid system of a suspended ceiling. It should be appreciated that various concepts introduced above and discussed in greater detail below may be implemented in any of numerous ways. In particular, some embodiments of the present disclosure described below relate particularly to LED-based light sources. It should be appreciated, however, that the present disclosure is not limited to any particular manner of implementation, and that the various embodiments discussed explicitly herein are primarily for purposes of illustration. For example, the various concepts discussed herein may be suitably implemented in a variety of environments involving LED-based light sources, other types of light sources not including LEDs, environments that involve both LEDs and other types of light sources in combination, and environments that involve non-lighting-related devices alone or in combination with various types of light sources.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum. The phosphor material may be located on the chip or remotely on a lens or other auxiliary optic component.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, plasma sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “light system” is used herein to refer to a “lighting fixture” in combination with a “light source.” The “lighting fixture” provides a mechanical and/or electrical interface with the “light source.” The “light source” generates light. A given light source may be associated with any one of a variety of lighting fixtures that provides mounting arrangements for the light source(s), enclosure/housing arrangements and shapes, and/or electrical and mechanical connection configurations. Additionally, a given light source optionally may be associated with (e.g., include, be coupled to and/or packaged together with) various other components (e.g., control circuitry) relating to the operation of the light source(s). An “LED-based light source” refers to a light source that includes one or more LED-based light sources as discussed above, alone or in combination with other non LED-based light sources. A “multi-channel” light source refers to an LED-based or non LED-based light source that includes at least two light sources configured to respectively generate different spectrums of radiation, wherein each different source spectrum may be referred to as a “channel” of the multi-channel light source.

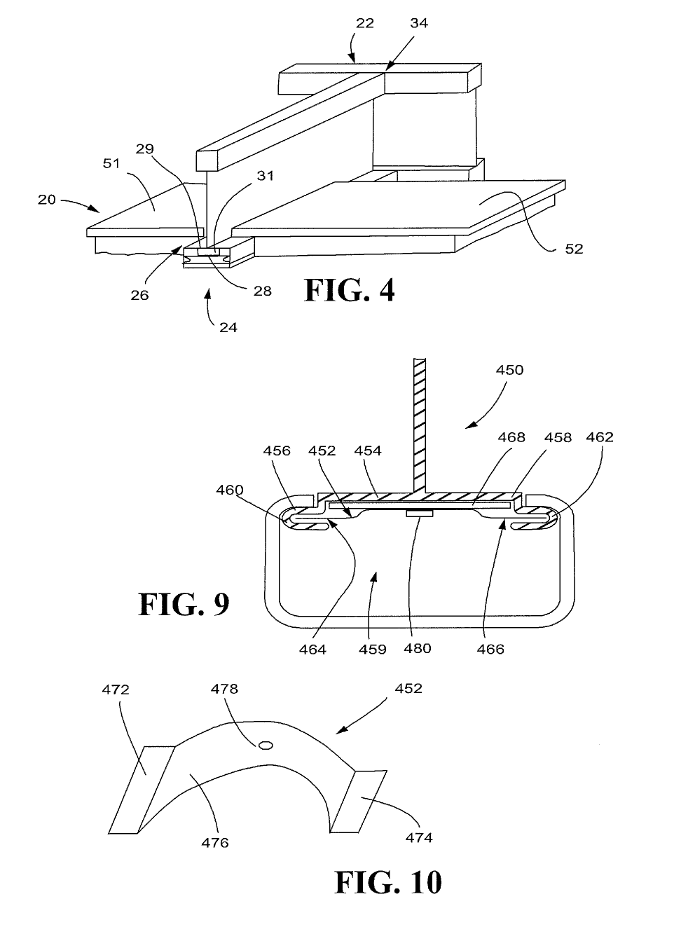

FIG. 4 illustrates a suspended ceiling 20 according to one embodiment of the present disclosure, in which at least a portion of a grid system 22 for the suspended ceiling 20 includes a lighting system 24. In one implementation, the lighting system 24 includes one or more lighting fixtures 26 that form at least a portion of the grid system 22, and one or more light sources 28 coupled to the lighting fixture(s) 26. Various types of light sources 28 suitable for use in the lighting system 24, including LED-based light sources, are discussed in greater detail below. The light source 28 may include lead wires 29, 31 for connection to a power source.

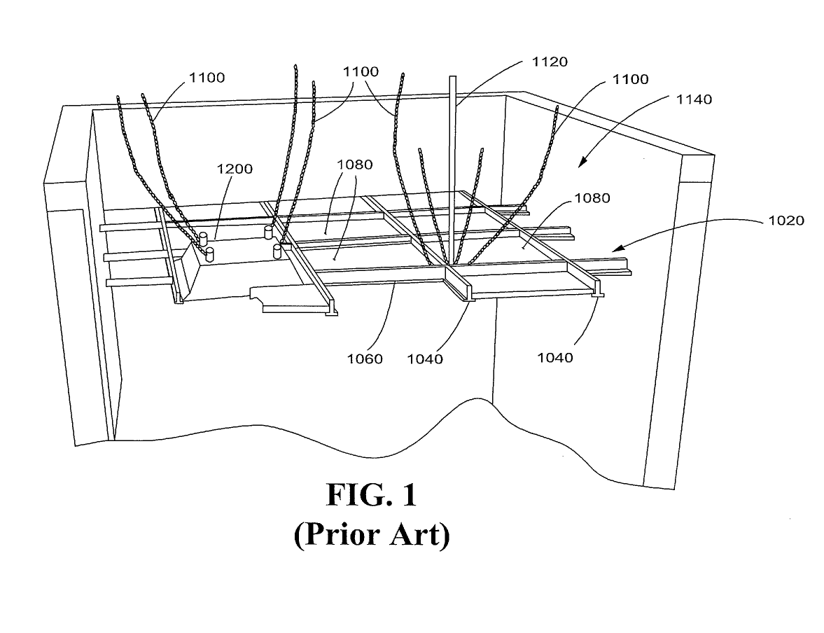

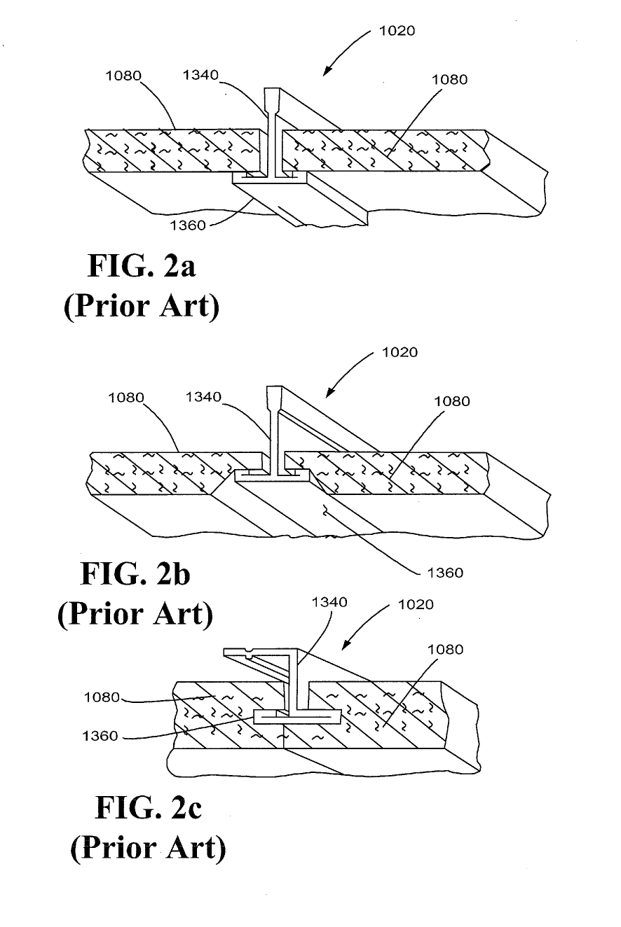

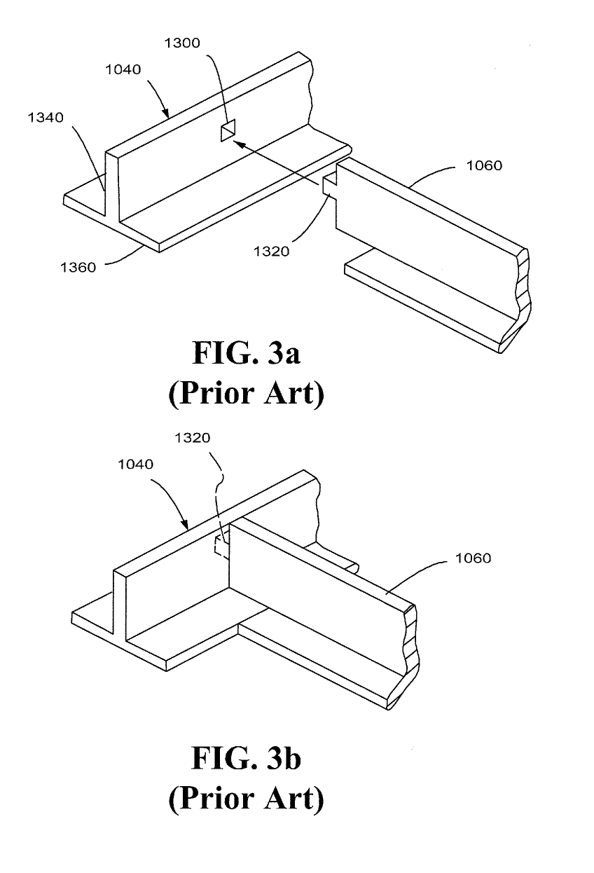

As can be seen in FIG. 4, one or more lighting fixtures 26 may form only a portion of the grid system 22. In such an implementation, the grid system may include one or more conventional main channels 1040 and one or more conventional cross channels 1060 as discussed above in connection with FIGS. 1-3. While the lighting fixture 26 illustrated in FIG. 4 as forming at least a portion of a cross channel of the grid system 22, it should be appreciated that grid systems for suspended ceilings according to the present disclosure are not limited in this respect, as one or more lighting fixtures 26 may form all or a portion of one or more main channels of the grid system in addition to (or instead of) one or more main channels. For example, the one or more lighting fixtures 26 may be formed and configured to constitute a substantial portion of (or essentially all of) the grid system 22 (i.e., including multiple main channels and multiple cross channels) to provide a distributed lighting system throughout the suspended ceiling. In the embodiment of FIG. 4, lighting fixture(s) 26 also may be particularly formed so as to provide one or more intersections 34 between main channels and cross channels of the grid system.

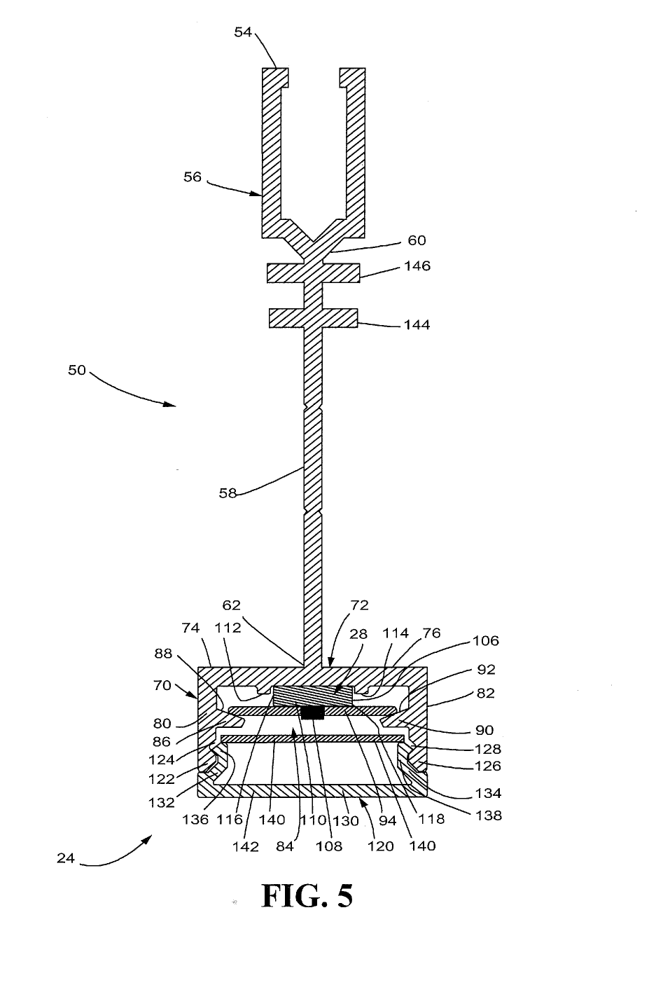

FIG. 5 illustrates a cross-sectional end view of a lighting system 24 formed as at least a portion of a suspended ceiling grid system, according to one embodiment of the present disclosure. The lighting system 24 includes a runner 50 configured to support one or more light sources 28 as well as first and second ceiling tiles 51, 52 (FIG. 4). Accordingly, the runner 50 may be used in place of all or a portion of a main channel or a cross channel. The runner 50 may be suspended via a rod or wire, or otherwise coupled to, an overhead structure above the suspended ceiling.

In the illustrated embodiment, the runner 50 includes an upper edge 54 that may be reinforced to increase the structural strength of the runner 50. For example, the upper edge 54 of the runner may be formed as a reinforcing bulb 56. The runner 50 may also include a web 58 having a first end 60 coupled to the upper edge 54 and a second end 62. The web 58 may have a substantially uniform, thin, elongate cross-sectional shape as shown in FIG. 5. In the illustrated embodiment, the reinforcing bulb 56 and web 58 have conventional shapes that are familiar to the installer, thereby facilitating proper and efficient installation as well as the use of standard, unmodified ceiling tiles.

The runner 50 further includes a fixture housing 70 coupled to the second end 62 of the web 58 for supporting the light source(s) 28 as well as other optional components. The fixture housing 70 includes a base 72 extending transversely to the web 58 to define first and second flanges 74, 76 disposed on opposite sides of the web 58. The first flange 74 is configured to support a first ceiling tile when the first ceiling tile is installed in the suspended ceiling, while the second flange 76 is configured to support a second ceiling tile when the second ceiling tile is installed in the suspended ceiling. In the exemplary embodiment, the first and second flanges 74, 76 extend outwardly from the web 58 in opposite lateral directions by a distance sufficient to support respective edges of the first and second ceiling tiles.

The fixture housing 70 further includes spaced, first and second side walls 80, 82 extending downwardly from the base 72 to define a fixture receptacle 84. The first and second side walls 80, 82 may have substantially planar exterior surfaces to facilitate use of conventional ceiling tiles. The first side wall may include a first support arm 86 extending from an interior surface into the fixture receptacle 84. The first support arm 86 may have an inclined upper surface 88 that descends as it extends farther into the fixture receptacle 84. The second side wall may similarly include a second support arm 90 having an inclined upper surface 92 that also descends as it extends into the fixture receptacle 84. The first and second support arms 86, 90 support the light source 28, as described in greater detail below.

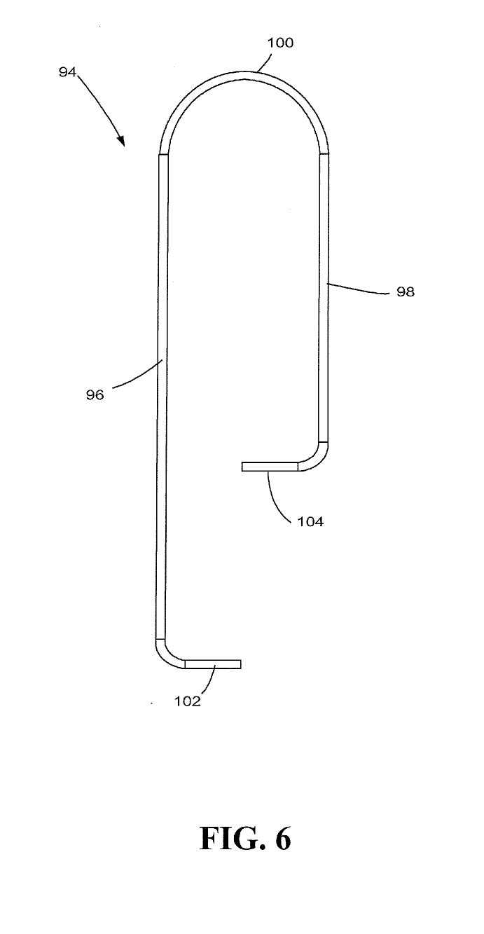

A retainer 94 is supported by the support arms 86, 90 and engages the light source 28 to secure the light source in place within the fixture receptacle 84. As best shown in FIG. 6, the retainer 94 includes first and second lateral segments 96, 98. The lateral segments 96, 98 are spaced so that they engage respective first and second support arms 86, 90 when assembled with the lighting fixture 26, and may be substantially parallel to one another as shown. An intermediate cross segment 100 joins ends of the first and second lateral segments 96, 98. A first terminal cross segment 102 is coupled to the first lateral segment 96, and a second terminal cross segment 104 is coupled to the second lateral segment 98. Each of the intermediate, first terminal, and second terminal cross segments 100, 102, 104 extends at least partially across the fixture receptacle 84 when the retainer 94 is assembled with the lighting fixture 26. The inclined upper surfaces 88, 92 of the first and second support arms 86, 90 urge the retainer 94 into a self-centered position, as shown in FIG. 5. The light source 28 may include a substrate body 106 carrying multiple light elements 108. The retainer 94 may be configured to engage a bottom surface 110 of the substrate body 106 without obstructing any of the light elements 108, thereby to secure the light source 28 in place.

As best shown in FIG. 5, first and second stops 112, 114 may project from the base 72 into the fixture receptacle 84. The first and second stops 112, 114 may be laterally spaced to receive the substrate body 106 therebetween, so that the stops 112, 114 facilitate assembly of the light source 28 in the desired location within the fixture receptacle 84. In the illustrated embodiment, the first and second stops 112, 114 engage first and second side surfaces 116, 118 of the substrate body 106.

While the illustrated embodiments show the light source 28 secured in place using the retainer 94, it will be appreciated that the light source 28 may be secured using screws, glue, clips, or other retention means.

The lighting fixture 26 described herein may also hold other components in addition to the light source 28. For example, a filter, lens, or other optical component may be used to achieve a desired lighting effect. In the exemplary embodiment illustrated in FIG. 5, an optical component such as a lens 120 may be releasably coupled to the lighting fixture 26. More specifically, the first side wall 80 may include a first lip 122 with a first detent 124, while the second side wall 82 may include a second lip 126 with a second detent 128. The lens 120 may be formed with an optical body 130 having first and second fingers 132, 134 projecting therefrom. The first finger 132 may have a first prong 136 configured to engage the first detent 124, while the second finger 134 may have a second prong 138 configured to engage the second detent 128. The first and second fingers 132, 134 may have a flexible construction to permit the fingers to flex inwardly to allow the first and second prongs 136, 138 to slide past the first and second lips 122, 126 as the fingers are inserted into the fixture receptacle 84. In addition to the lens 120, an additional optical component, such as second lens 140, may be disposed within the fixture receptacle 84. In the exemplary embodiment, the second lens 140 is supported by the lens 120, however the second lens 140 may be secured to the lighting fixture 26 by other means. Three or more optical components may further be secured by the lighting fixture 26.

The lens 120 may have various configurations depending on the desired appearance of the lighting fixture 26 relative to the dropped ceiling. For example, the optical body 130 of the lens 120 may define an outer surface 142 that may be recessed, flush with, or projecting downwardly from the surrounding ceiling tiles. Additionally or alternatively, the lens 120 may be colored or configured to produce a desired light distribution, such as spot, flood, wall wash, wall graze, uplight, or asymmetric light distributions. Such optical components may be formed of relatively thin layers of paper, acrylic ribbon, or other material. The lens 120 may include an accessory filter (such as a decorative stencil, a color gel, or other diffusing media) disposed behind the outer surface 142, and may be formed with various profiles to obtain asymmetric or different distributions and brightness. The lens 120 may be solid or may be formed with lenticular patterns to create different light distributions along any desired axis. Additionally, the lens 120 may have a uniform or varying thickness depending on the desired light distribution.

In various aspects, the lighting fixture 26 may be configured to direct and dissipate heat generated by the light source 28. For example, the runner 50 may be formed of a low thermal resistance material, such as aluminum. Additionally, the shape of the lighting fixture 26 may be configured to dissipate heat in a desired location. For example, first and second cooling fins 144, 146 may be formed in the web 58 that extend substantially transversely relative to the web 58. While the illustrated embodiment shows two spaced cooling fins 144, 146, it will be appreciated that zero, one, or more than two cooling fins may be used.

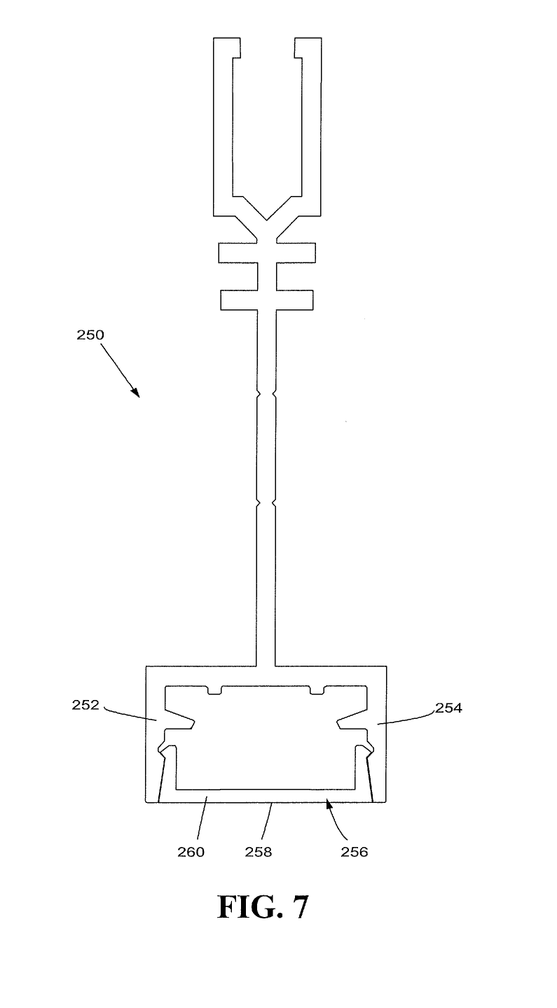

FIG. 7 illustrates an alternative embodiment of a runner 250 having first and second side walls 252, 254 configured to receive an alternative lens 256. More specifically, the first and second side walls 252, 254 may be elongated so that an outer surface 258 of an optical body 260 of the lens 256 is substantially flush with free ends of the first and second side walls 252, 254.

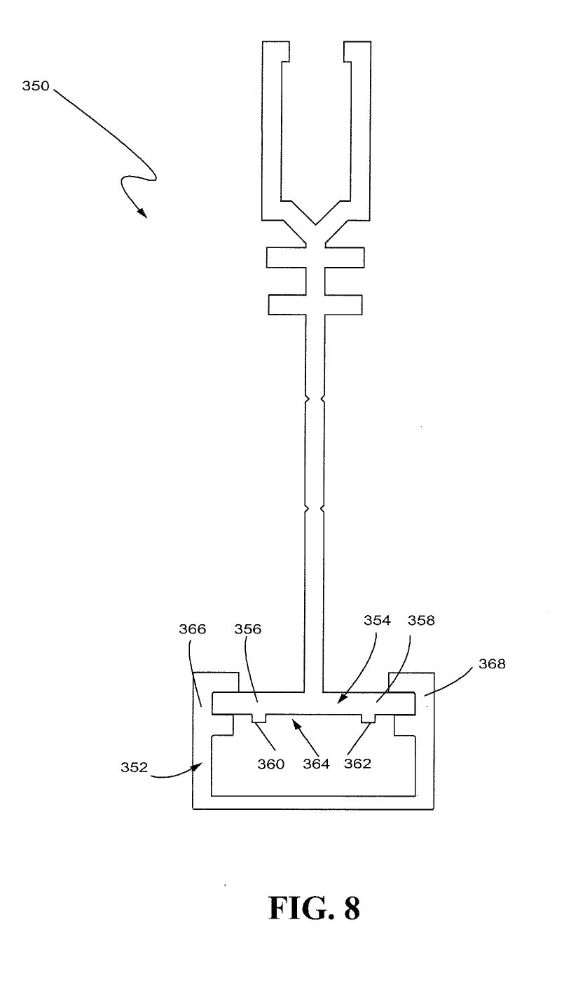

FIG. 8 illustrates yet another alternative embodiment of a runner 350 that omits the first and second side walls but is configured to receive a modified lens 352. The runner 350 includes a fixture base 354 defining first and second flanges 356, 358 for supporting ceiling tiles (not shown). First and second stops 360, 362 may project from the fixture base 354 to define a fixture receptacle 364 sized to receive a light source (not shown). The lens 352 includes first and second channels 366, 368 configured to engage opposite edges of the base 354.

FIGS. 9 and 10 illustrate a further embodiment of a runner 450 and retainer 452. The runner 450 may include a base 454, with first and second side walls 456, 458 projecting from opposite ends of the base 454 to define a fixture receptacle 459. Each of the first and second side walls 456, 458 is formed with an inwardly facing channel 460, 462 defining respective slots 464, 466. A light source 468 is secured within the fixture receptacle 459 with one or more retainers 452. As best shown in FIG. 10, the retainer 452 may include first and second tabs 472, 474 connected by an arcuate body 476. The first and second tabs 472, 474 are configured for insertion into respective slots 464, 466, so that the arcuate body 476 engages and secures the light source 468 in place. The arcuate body 476 may include an aperture 478 sized to permit an LED unit 480 provided on the light source to extend at least partially through the arcuate body 476, so that the retainer 470 does not obstruct light generated by the light source 468.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A lighting fixture that forms at least a portion of a grid system for a suspended ceiling, the lighting fixture comprising:
a runner having:
an upper edge;
a web having a first end coupled to the upper edge and a second end;
a fixture base coupled to the web and defining first and second flanges disposed on opposite sides of the web, the first flange configured to support a first ceiling tile when the first ceiling tile is installed in the suspended ceiling, and the second flange configured to support a second ceiling tile when the second ceiling tile is installed in the suspended ceiling; and
a fixture receptacle associated with the fixture base; and
a light source secured inside the fixture receptacle.

2. The lighting fixture of claim 1, further comprising spaced first and second side walls coupled to the base, in which the base, first side wall, and second side wall define the fixture receptacle.

3. The lighting fixture of claim 2, in which the first side wall includes a first support arm extending into the fixture receptacle and the second side wall includes a second support arm extending into the fixture receptacle, wherein the first and second support arms support the light source.

4. The lighting fixture of claim 3, further comprising a retainer configured to extend from the first support arm to the second support arm, the retainer engaging the light source to secure the light source inside the fixture receptacle.

5. The lighting fixture of claim 1, in which the light source comprises a substrate body having first and second side surfaces, and in which the base includes first and second stops extending into the fixture receptacle, wherein the first and second stops are laterally spaced to respectively engage first and second side surfaces of the substrate body.

6. The lighting fixture of claim 1, in which the runner is formed of a heat conductive material, and in which the runner further includes a cooling fin coupled to the web and extending substantially transversely relative to the web.

7. The lighting fixture of claim 1, further comprising a lens releasably coupled to the runner.

8. The lighting fixture of claim 1, in which the fixture receptacle is disposed below the first and second flanges when the runner is installed in the suspended ceiling.

9. The lighting fixture of claim 1, in which the upper edge of the runner comprises a reinforcing bulb.

10. A lighting fixture that forms at least a portion of a grid system for a suspended ceiling, the lighting fixture comprising:
a runner having:
an upper edge;
a web having a first end coupled to the upper edge and a second end;
a fixture base coupled to the web and defining first and second flanges disposed on opposite sides of the web, the first flange configured to support a first ceiling tile when the first ceiling tile is installed in the suspended ceiling, and the second flange configured to support a second ceiling tile when the second ceiling tile is installed in the suspended ceiling;
spaced first and second side walls coupled to the base so that the base, first side wall, and second side wall define a fixture receptacle;
a first support arm extending from the first side wall and into the fixture receptacle; and
a second support arm extending from the second side wall and into the fixture receptacle;
a light source disposed inside the fixture receptacle; and
a retainer configured to extend from the first support arm to the second support arm, the retainer engaging the light source to secure the light source inside the fixture receptacle.

11. The lighting fixture of claim 10, in which the light source comprises a substrate body having first and second side surfaces, and in which the base includes first and second stops extending into the fixture receptacle, wherein the first and second stops are laterally spaced to respectively engage first and second side surfaces of the substrate body.

12. The lighting fixture of claim 10, in which the runner is formed of a heat conductive material, and in which the runner further includes a cooling fin coupled to the web and extending substantially transversely relative to the web.

13. The lighting fixture of claim 10, further comprising a lens releasably coupled to the lighting fixture.

14. The lighting fixture of claim 10, in which the fixture receptacle is disposed below the first and second flanges when the runner is installed in the suspended ceiling.

15. The lighting fixture of claim 10, in which the upper edge of the runner comprises a reinforcing bulb.

16. A lighting fixture that forms at least a portion of a grid system for a suspended ceiling, the lighting fixture comprising:
a runner having:
an upper edge;
a substantially uniform, elongate, thin web having a first end coupled to the upper edge and a second end;
a fixture base coupled to the web and defining first and second flanges disposed on opposite sides of the web, the first flange configured to support a first ceiling tile when the first ceiling tile is installed in the suspended ceiling, and the second flange configured to support a second ceiling tile when the second ceiling tile is installed in the suspended ceiling;
spaced first and second side walls coupled to the base so that the base, first side wall, and second side wall define a fixture receptacle;
a first support arm extending from the first side wall and into the fixture receptacle; and
a second support arm extending from the second side wall and into the fixture receptacle;
a light source disposed inside the fixture receptacle; and
a retainer configured to extend from the first support arm to the second support arm, the retainer engaging the light source to secure the light source inside the fixture receptacle.

17. The lighting fixture of claim 16, in which the light source comprises a substrate body having first and second side surfaces, and in which the base includes first and second stops extending into the fixture receptacle, wherein the first and second stops are laterally spaced to respectively engage first and second side surfaces of the substrate body.

18. The lighting fixture of claim 16, in which the runner is formed of a heat conductive material, and in which the runner further includes a cooling fin coupled to the web and extending substantially transversely relative to the web.

19. The lighting fixture of claim 16, further comprising a lens releasably coupled to the lighting fixture.

20. The lighting fixture of claim 16, in which the fixture receptacle is disposed below the first and second flanges when the runner is installed in the suspended ceiling.
